(19) United States
(12) Patent Application Publication
(10) Pub. No.: US 2010/0125510 A1
(43) Pub. Date: May 20, 2010

(54) SYSTEM AND METHOD OF CONDUCTING TRANSACTIONS USING A MOBILE WALLET SYSTEM

(76) Inventors: Steven M. Smith, Cumming, GA (US); Brady L. Rackley, Atlanta, GA (US); Ben D. Ackerman, Atlanta, GA (US); Nanci Rainey, Atlanta, GA (US); Warren D. Porter, Atlanta, GA (US); Aidoo Osei, Atlanta, GA (US); Robert L. Dessert, Atlanta, GA (US); Karthik R. Iyer, Atlanta, GA (US); Kyle Cochran, Atlanta, GA (US); James P. Mason, Atlanta, GA (US); Scott P. Monahan, Atlanta, GA (US)

Correspondence Address: QUALCOMM INCORPORATED, 5775 MOREHOUSE DR., SAN DIEGO, CA, 92121, US

(21) Appl. No.: 12/562,593

(22) Filed: Sep. 18, 2009

Related U.S. Application Data
(60) Provisional application No. 61/115,454, filed on Nov. 17, 2008.
(60) Provisional application No. 61/115,453, filed on Nov. 17, 2008.

(51) Int. Cl. G06Q 20/00; G06Q 30/00; G06Q 40/00

(52) U.S. Cl. 705/17; 705/41

(57) ABSTRACT

A method of managing transactions between a mobile wallet within a mobile device and a point-of-sale terminal at a merchant is disclosed and may include receiving a request for a purchase code from the mobile wallet, generating a short-term purchase code, transmitting the short-term purchase code to the mobile wallet, and receiving the short-term purchase code from the merchant.

### FIELD

The present application claims priority to and incorporates by reference in its entirety U.S. Provisional Patent Application Ser. No. 61/115,454, entitled SYSTEM AND METHOD OF CONDUCTING TRANSACTIONS USING A MOBILE WALLET SYSTEM, filed on Nov. 17, 2008. Further, the present application claims priority to and incorporates by reference in its entirety U.S. Provisional Patent Application Ser. No. 61/115,453, entitled SYSTEM AND METHOD OF PROVIDING A MOBILE WALLET AT A MOBILE TELEPHONE, filed on Nov. 17, 2008. The present application incorporates by reference U.S. patent application Ser. No. ______ (Attorney Docket No. 090666U1) entitled SYSTEM AND METHOD OF PROVIDING A MOBILE WALLET AT A MOBILE TELEPHONE, filed on ______.

### FIELD

The present invention generally relates to wireless transactions, and more particularly, to conducting transactions using a mobile wallet system.

### DESCRIPTION OF THE RELATED ART

Typically, a person may have multiple bank accounts, multiple credit card accounts, gift card accounts, etc. Each account provider may provide online access to each account and a customer may manage each account separately via a separate online portal. When a customer is actually shopping, e.g., at a traditional brick-and-mortar store or electronically, i.e., online or via a mobile telephone network, the customer may not have ready access to particular account details. Further, when using a mobile telephone to shop at a mobile store provided via a mobile telephone network, the shopping process and the checkout process may be relatively time consuming. This experience may be quite negative and may cause a customer to not further utilize the mobile store.

Accordingly, what is needed is an improved system and method of conducting transactions using a mobile wallet accessible via a mobile device.

### SUMMARY OF THE DISCLOSURE

A method of managing transactions between a mobile wallet within a mobile device and a point-of-sale terminal at a merchant is disclosed and may include receiving a request for a purchase code from the mobile wallet, generating a short-term purchase code, transmitting the short-term purchase code to the mobile wallet, and receiving the short-term purchase code from the merchant.

Further, the method may include determining whether the short-term purchase code is expired, determining whether the short-term purchase code is valid, and transmitting user account information to the merchant when the short-term purchase code is not expired and is valid. Also, the method may include receiving transaction information from an account provider, updating the mobile wallet associated with the mobile device to include the transaction information from the account provider, and transmitting an updated wallet to the mobile device.

In another aspect, a server for managing transactions between a mobile wallet within a mobile device and a point-of-sale terminal at a merchant is disclosed and may include means for receiving a request for a purchase code from the mobile wallet, means for generating a short-term purchase code, means for transmitting the short-term purchase code to the mobile wallet, and means for receiving the short-term purchase code from the merchant.

Moreover, the server may include means for determining whether the short-term purchase code is expired, means for determining whether the short-term purchase code is valid, and means for transmitting user account information to the merchant when the short-term purchase code is not expired and is valid. Further, the server may include means for receiving transaction information from an account provider, means for updating the mobile wallet associated with the mobile device to include the transaction information from the account provider, and means for transmitting an updated wallet to the mobile device.

In yet another aspect, a server for managing transactions between a mobile wallet within a mobile device and a point-of-sale terminal at a merchant is disclosed and may include a processor. The processor may be operable to receive a request for a purchase code from the mobile wallet, generate a short-term purchase code, transmit the short-term purchase code to the mobile wallet and receive the short-term purchase code from the merchant. The processor is further operable determine whether the short-term purchase code is expired, determine whether the short-term purchase code is valid, and transmit user account information to the merchant when the short-term purchase code is not expired and is valid. Moreover, the processor may be operable to receive transaction information from an account provider, update the mobile wallet associated with the mobile device to include the transaction information from the account provider, and transmit an updated wallet to the mobile device.

In another aspect, a computer program product is disclosed and may include a computer-readable medium. The computer-readable medium may include at least one instruction for receiving a request for a purchase code from the mobile wallet, at least one instruction for generating a short-term purchase code, at least one instruction for transmitting the short-term purchase code to the mobile wallet, and at least one instruction for receiving the short-term purchase code from the merchant.

Further, the computer-readable medium may include at least one instruction for determining whether the short-term purchase code is expired, at least one instruction for determining whether the short-term purchase code is valid, and at least one instruction for transmitting user account information to the merchant when the short-term purchase code is not expired and is valid. The computer readable-medium may also include at least one instruction for receiving transaction information from an account provider, at least one instruction for updating the mobile wallet associated with the mobile device to include the transaction information from the account provider, and at least one instruction for transmitting an updated wallet to the mobile device.

In still another aspect, a method of managing transactions between a mobile wallet within a mobile device and a mobile store is disclosed and may include receiving a transaction request from the mobile store, receiving a customer identifier from the mobile store, retrieving the mobile wallet associated with the mobile device, and retrieving customer account information from the mobile wallet. The customer account information includes at least one of the following: a preferred payment account, a default billing address, and a default shipping address.

In this aspect, the method may also include receiving transaction information from an account provider, when the transaction is approved; updating the mobile wallet associated with the mobile device; and transmitting an updated wallet to the mobile device.

In another aspect, a server for managing transactions between a mobile wallet within a mobile device and a mobile store is disclosed and may include means for receiving a transaction request from the mobile store, means for receiving a customer identifier from the mobile store, means for retrieving the mobile wallet associated with the mobile device, and means for retrieving customer account information from the mobile wallet. The customer account information includes at least one of the following: a preferred payment account, a default billing address, and a default shipping address.

The server may also include means for receiving transaction information from an account provider, when the transaction is approved; means for updating the mobile wallet associated with the mobile device; and means for transmitting an updated wallet to the mobile device.

In yet another aspect, a server for managing transactions between a mobile wallet within a mobile device and a mobile store is disclosed and may include a processor. The processor may be operable to receive a transaction request from the mobile store, receive a customer identifier from the mobile store, retrieve the mobile wallet associated with the mobile device, and retrieve customer account information from the mobile wallet. The customer account information may include at least one of the following: a preferred payment account, a default billing address, and a default shipping address.

In this aspect, the processor is further operable to receive transaction information from an account provider, when the transaction is approved; update the mobile wallet associated with the mobile device; and transmit an updated wallet to the mobile device.

In another aspect, a computer program product is disclosed and may include a computer-readable medium. The computer-readable medium may include at least one instruction for receiving a transaction request from the mobile store, at least one instruction for receiving a customer identifier from the mobile store, at least one instruction for retrieving the mobile wallet associated with the mobile device, and at least one instruction for retrieving customer account information from the mobile wallet. The customer account information may include at least one of the following: a preferred payment account, a default billing address, and a default shipping address.

In this aspect, the computer-readable medium may also include at least one instruction for receiving transaction information from an account provider, when the transaction is approved; at least one instruction for updating the mobile wallet associated with the mobile device; and at least one instruction for transmitting an updated wallet to the mobile device.

### BRIEF DESCRIPTION OF THE DRAWINGS

In the figures, like reference numerals refer to like parts throughout the various views unless otherwise indicated.

FIG. 1 is a diagram of a first aspect of a mobile wallet system;

FIG. 2 is a diagram of a second aspect of a mobile wallet system;

FIG. 3 is a diagram of a telephone;

FIG. 4 is a flowchart illustrating a method of conducting transactions at a point-of-sale terminal with a mobile device;

FIG. 5 is a flowchart illustrating a method of handling one or more point-of-sale transactions at a wallet server;

FIG. 6 is a flowchart illustrating a method of conducting transactions with a mobile device at a point-of-sale terminal;

FIG. 7 is a flowchart illustrating a method of conducting transactions with a mobile store from a mobile device;

FIG. 8 is a flowchart illustrating a method of managing transactions between a mobile device and a mobile store at a wallet server is shown; and

FIG. 9 is a flowchart illustrating a method of conducting transactions with a mobile device at a mobile store.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

In this description, the terms “communication device,” “wireless device,” “wireless telephone,” “wireless communications device,” and “wireless handset” are used interchangeably. With the advent of third generation (3G) wireless technology, more bandwidth availability has enabled more electronic devices with wireless capabilities. Therefore, a wireless device could be a cellular telephone, a pager, a PDA, a smartphone, a navigation device, or a computer with a wireless connection.

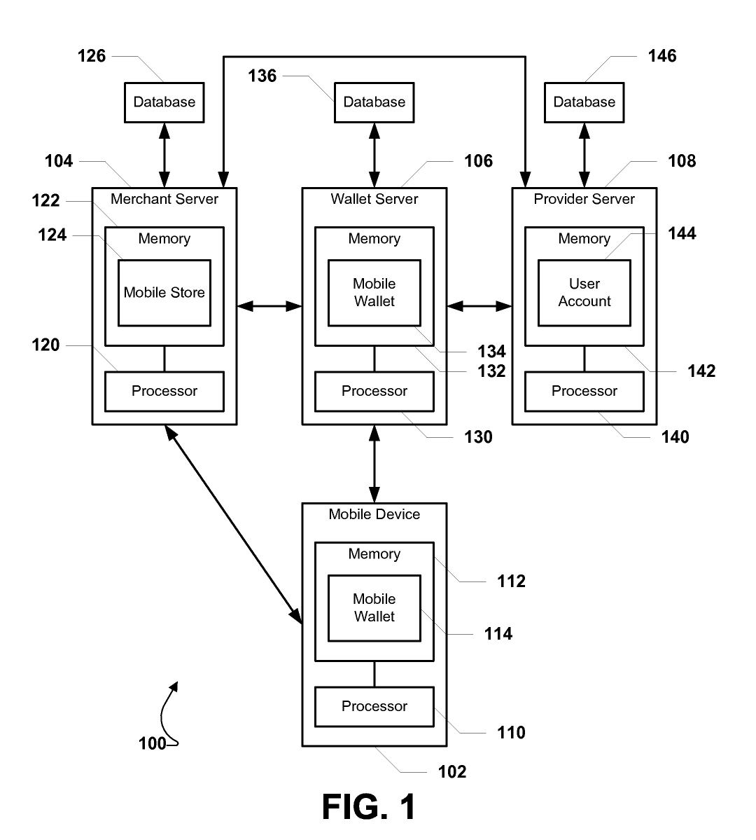

Referring to FIG. 1, a first aspect of a mobile device purchasing system is shown and is generally designated 100. As shown, the system 100 may include a mobile device 102. A merchant server 104 may be connected to the mobile device 102, e.g., via a mobile telephone network. A wallet server 106 may be connected to the mobile device 102 and the merchant server 104. The wallet server 106 may be connected to the mobile device 102 via a mobile telephone network. Further, the wallet server 106 may be connected to the merchant server 104 via a wide area network (WAN), e.g., the Internet. FIG. 1 also shows a provider server 108 connected to the wallet server 106, e.g., via a WAN.

As illustrated in FIG. 1, the mobile device 102 may include a processor 110 and a memory 112 coupled to the processor 110. The memory 112 may include one or more of the method steps described herein. Further, the processor 110 and the memory 112 may serve as a means for executing one or more of the method steps described herein. As indicated, the memory 112 may also include a mobile wallet 114. The mobile wallet may be provided to the mobile device 102 by the wallet server 106.

The merchant server 104 may also include a processor 120 and a memory 122 coupled to the processor 110. The memory 122 may include one or more of the method steps described herein. Further, the processor 120 and the memory 122 may serve as a means for executing one or more of the method steps described herein. As shown, the memory 122 may include a mobile store 124. The mobile store 124 may be accessed by the mobile device 102 and may allow a user of the mobile device 102 to browse and purchase items provided for sale at the mobile store 124. A database 126 may be connected to the merchant server 104. The database 126 may be used to stored information regarding items for sale at the mobile store 124.

FIG. 1 shows that the wallet server 106 may include a processor 130 and a memory 132 coupled to the processor 130. The memory 132 may include one or more of the method steps described herein. Further, the processor 130 and the memory 132 may serve as a means for executing one or more of the method steps described herein. As illustrated, the memory 132 may include a mobile wallet 134. The mobile wallet 134 within the wallet server 106 may be similar to the mobile wallet 114 stored within the mobile device 102. Further, the mobile wallet 134 within the wallet server 106 may include substantially the same information as the mobile wallet 114 stored within the mobile device 102. A database 136 may also be connected to the wallet server 106. The database 136 may include one or more other mobile wallets associated with other mobile devices.

As depicted in FIG. 1, the provider server 108 may include a processor 140 and a memory 142 coupled to the processor 140. The memory 142 may include one or more of the method steps described herein. Further, the processor 140 and the memory 142 may serve as a means for executing one or more of the method steps described herein. As illustrated, the memory 142 may include a user account 144 associated with a user of the mobile device 102. A database 146 may also be connected to the provider server 108. The database 146 may include account information associated with the user account 144 and account information associated with other user accounts associated with other mobile devices.

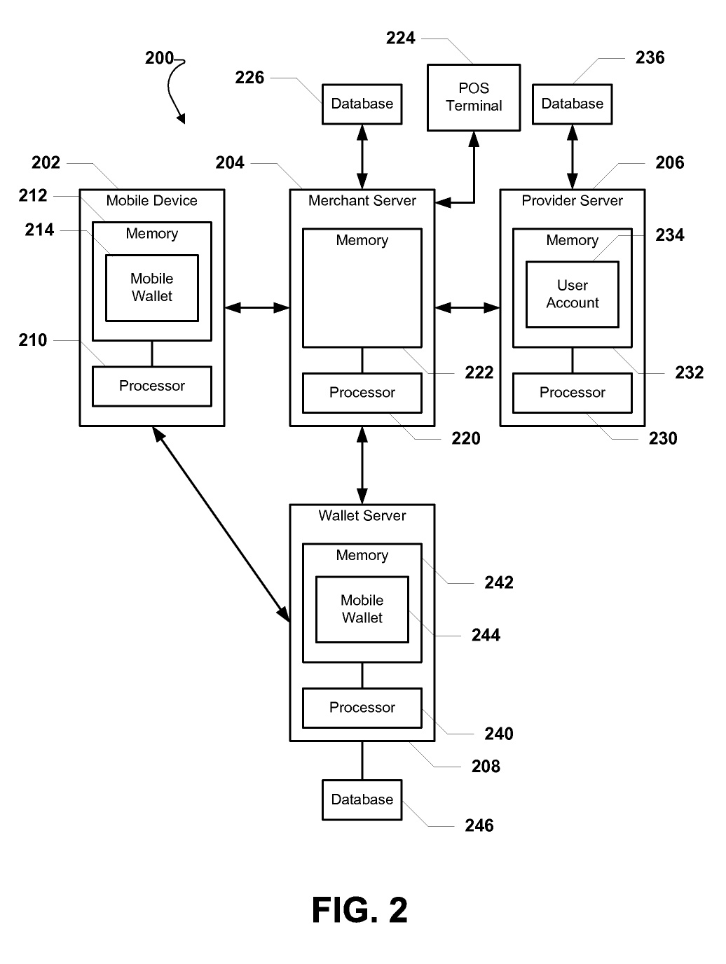

Referring now to FIG. 2, a second aspect of a mobile device purchasing system is shown and is generally designated 200. As shown, the system 200 may include a mobile device 202 and a merchant server 204. Further, a provider server 206 may be connected to the merchant server 204 via a WAN, or other network. FIG. 2 also shows that a wallet server 208 may also be connected to the mobile device 202, e.g., via a mobile telephone network. The wallet server 208 may also be connected to the merchant server 204 via a network, e.g., a WAN or other network.

In a particular aspect, the mobile device 202 may include a processor 210 and a memory 212 coupled to the processor 210. The memory 212 may include one or more of the method steps described herein. Further, the processor 210 and the memory 212 may serve as a means for executing one or more of the method steps described herein. As indicated, the memory 212 may also include a mobile wallet 214. The mobile wallet may be provided to the mobile device 202 by the wallet server 206.

The merchant server 204 may also include a processor 220 and a memory 222 coupled to the processor 210. The memory 222 may include one or more of the method steps described herein. Further, the processor 220 and the memory 222 may serve as a means for executing one or more of the method steps described herein. As shown, a point of sale (POS) terminal 224 may be connected to the merchant server 204. Further, a database 226 may be connected to the merchant server 204. The mobile device 202 may interact with the POS terminal, as described herein, in order to purchase goods at a brick-and-mortar store in which the merchant server 204 is located. The database 226 may be used to stored information regarding items for sale.

As depicted in FIG. 2, the provider server 206 may include a processor 230 and a memory 232 coupled to the processor 230. The memory 232 may include one or more of the method steps described herein. Further, the processor 230 and the memory 232 may serve as a means for executing one or more of the method steps described herein. As illustrated, the memory 232 may include a user account 234 associated with a user of the mobile device 202. A database 236 may also be connected to the provider server 206. The database 236 may include account information associated with the user account 234 and account information associated with other user accounts associated with other mobile devices.

FIG. 2 shows that the wallet server 208 may include a processor 240 and a memory 242 coupled to the processor 240. The memory 242 may include one or more of the method steps described herein. Further, the processor 240 and the memory 242 may serve as a means for executing one or more of the method steps described herein. As illustrated, the memory 242 may include a mobile wallet 244. The mobile wallet 244 within the wallet server 208 may be similar to the mobile wallet 214 stored within the mobile device 202. Further, the mobile wallet 244 within the wallet server 208 may include substantially the same information as the mobile wallet 214 stored within the mobile device 202. A database 246 may also be connected to the wallet server 208. The database 246 may include one or more other mobile wallets associated with other mobile devices.

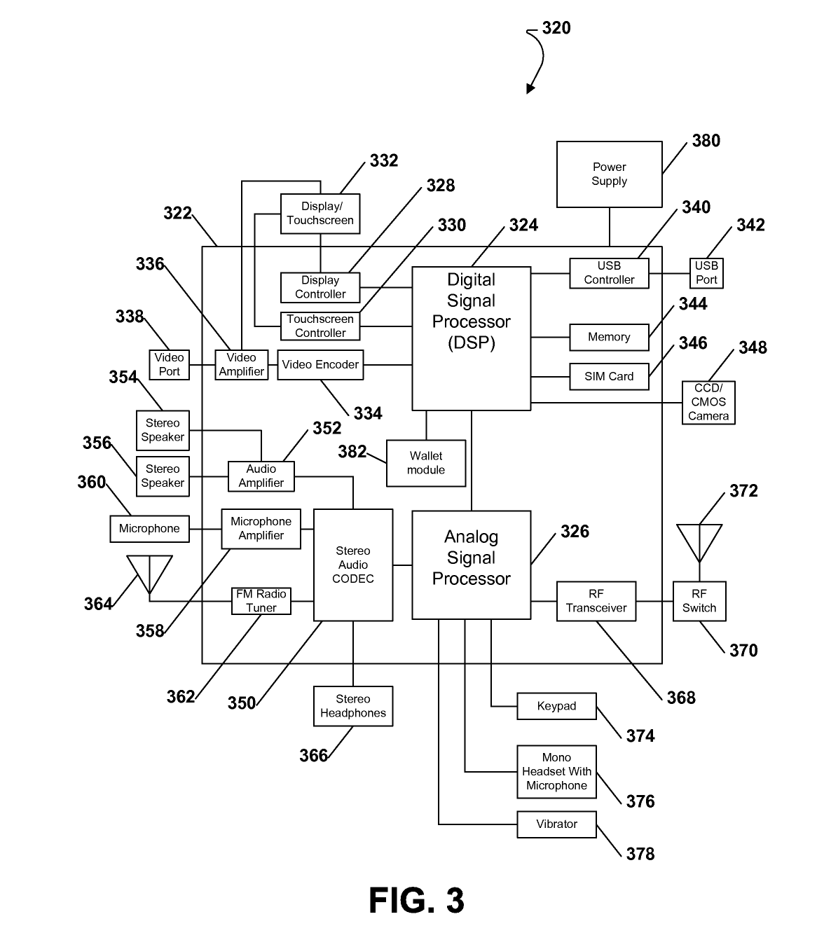

Referring to FIG. 3, an exemplary, non-limiting aspect of a wireless telephone is shown and is generally designated 320. As shown, the wireless device 320 includes an on-chip system 322 that includes a digital signal processor 324 and an analog signal processor 326 that are coupled together. As illustrated in FIG. 3, a display controller 328 and a touchscreen controller 330 are coupled to the digital signal processor 324. In turn, a touchscreen display 332 external to the on-chip system 322 is coupled to the display controller 328 and the touchscreen controller 330.

FIG. 3 further indicates that a video encoder 334, e.g., a phase alternating line (PAL) encoder, a sequential couleur a memoire (SECAM) encoder, or a national television system(s) committee (NTSC) encoder, is coupled to the digital signal processor 324. Further, a video amplifier 336 is coupled to the video encoder 334 and the touchscreen display 332. Also, a video port 338 is coupled to the video amplifier 336. As depicted in FIG. 3, a universal serial bus (USB) controller 340 is coupled to the digital signal processor 324. Also, a USB port 342 is coupled to the USB controller 340. A memory 344 and a subscriber identity module (SIM) card 346 may also be coupled to the digital signal processor 324. Further, as shown in FIG. 3, a digital camera 348 may be coupled to the digital signal processor 324. In an exemplary aspect, the digital camera 348 is a charge-coupled device (CCD) camera or a complementary metal-oxide semiconductor (CMOS) camera.

As further illustrated in FIG. 3, a stereo audio CODEC 350 may be coupled to the analog signal processor 326. Moreover, an audio amplifier 352 may coupled to the stereo audio CODEC 350. In an exemplary aspect, a first stereo speaker 354 and a second stereo speaker 356 are coupled to the audio amplifier 352. FIG. 3 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 3 further indicates that a radio frequency (RF) transceiver 368 may be coupled to the analog signal processor 326. An RF switch 370 may be coupled to the RF transceiver 368 and an RF antenna 372. As shown in FIG. 3, a keypad 374 may be coupled to the analog signal processor 326. Also, a mono headset with a microphone 376 may be coupled to the analog signal processor 326. Further, a vibrator device 378 may be coupled to the analog signal processor 326. FIG. 3 also shows that a power supply 380 may be coupled to the on-chip system 322. In a particular aspect, the power supply 380 is a direct current (DC) power supply that provides power to the various components of the wireless device 320 that require power. Further, in a particular aspect, the power supply is a rechargeable DC battery or a DC power supply that is derived from an alternating current (AC) to DC transformer that is connected to an AC power source.

FIG. 3 also shows that the wireless device 320 may include a wallet module 382. The wallet module 382 may communicate with a wallet server to update wallet information stored in the wireless device 320.

As depicted in FIG. 3, the touchscreen display 332, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 are external to the on-chip system 322.

In a particular aspect, one or more of the method steps described herein may be stored in the memory 344 as computer program instructions. These instructions may be executed by a processor 324, 326 in order to perform the methods described herein. Further, the processors, 324, 326, the memory 344, the instructions stored therein, or a combination thereof may serve as a means for performing one or more of the method steps described herein.

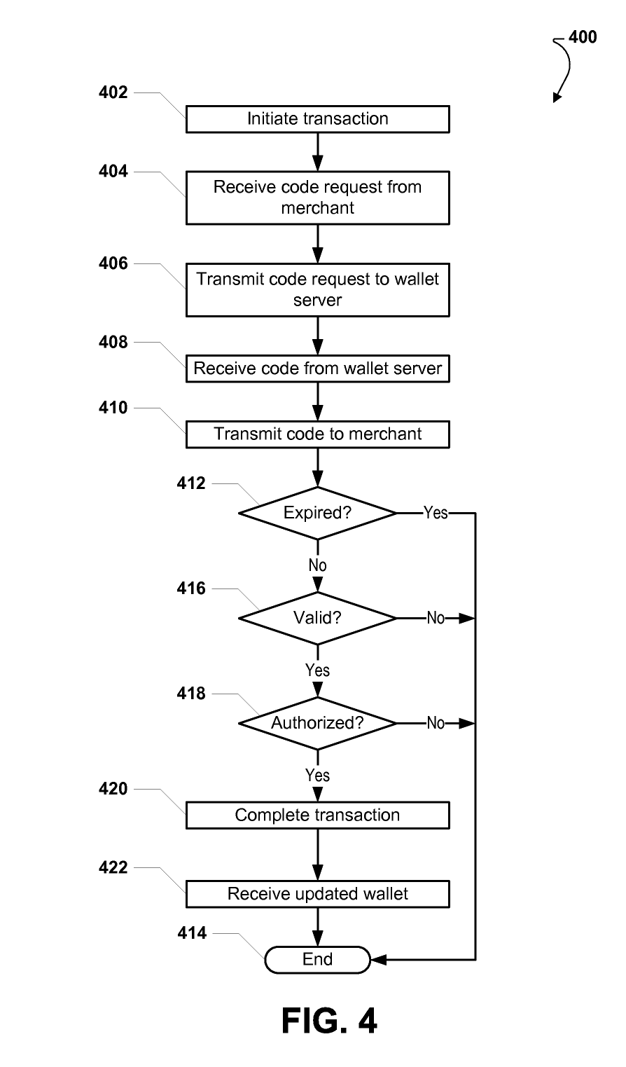

Referring now to FIG. 4, a method of conducting transactions at a point-of-sale terminal with a mobile device is shown and is designated 400. Commencing at block 402, the user of the mobile device may initiate a transaction. At block 404, the user may receive a code request from a merchant. At block 406, the user may transmit the code request to a wallet server, e.g., using the mobile device. Moving to block 408, the mobile device may receive the code from the wallet server. The code may be a randomly generated, short-term code that may expire within predetermined time period, e.g., five minutes or less.

Proceeding to block 410, the code may be transmitted to the merchant, e.g., verbally. Alternatively, the code may be transmitted to the merchant using blue tooth or some other relatively short distance wireless transmission means, e.g., near field communications (NFC). At decision step 412, the mobile device, or the user thereof, may receive an indication from the merchant indicating whether or not the code is expired. If so, the method 400 may end at state 414. Otherwise, the method 400 may continue to decision step 416 and the mobile device, or the user thereof, may receive an indication from the merchant indicating whether or not the code is expired. If so, the method 400 may end at state 414. Conversely, the method may proceed to decision step 418 and the mobile device, or the user thereof, may receive an indication from the merchant indicating whether or not the code is authorized. If the code is not authorized, the method 400 may end at state 414. If the code is authorized, the method 400 may continue to block 420 and the transaction may be completed. Thereafter, at block 422, an updated wallet may be received from the wallet server. The method 400 may then end at state 414.

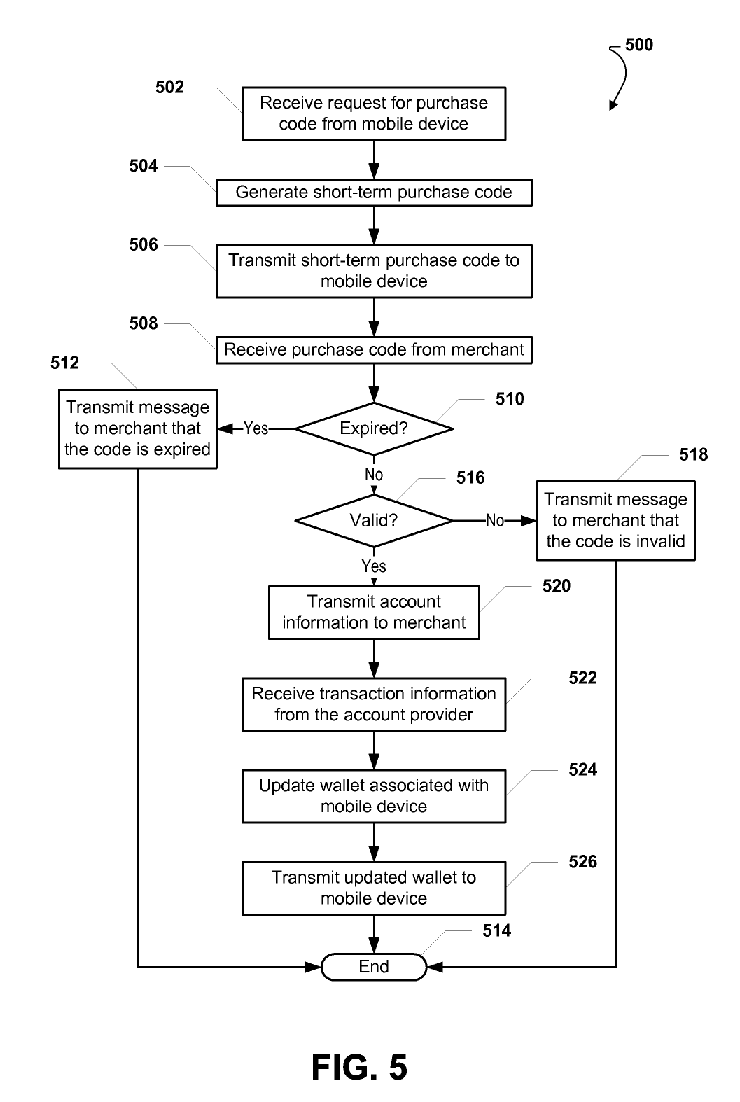

FIG. 5 illustrates a method 500 of handling one or more point-of-sale transactions at a wallet server. Beginning at block 502, the wallet server may include a request for a purchase code from a mobile device. At block 504, the wallet server may generate a short-term purchase code. Thereafter, at block 506, the wallet server may transmit the short-term purchase code to the mobile device. Moving to block 508, the wallet server may receive the purchase code from the merchant.

At decision step 510, the wallet server may determine whether the purchase code is expired. If so, the method 500 may continue to block 512 and the wallet server may transmit a message to the merchant that the code is expired. Thereafter, the method 500 may end at state 514. Returning to decision step 510, if the code is not expired, the method 500 may move to decision step 516 and the wallet server may determine whether the code is valid. If not, the method may continue to block 518 and the wallet server may transmit a message to the merchant that the code is invalid. The method may then end at state 514.

Returning to decision step 516, if the code is valid, the method may proceed to block 520 and the wallet server may transmit account information to the merchant. The account information may include a preferred payment account, a default billing address, a default shipping address, and any other information necessary to complete the transaction. Next, at block 522, the wallet server may receive transaction information from the account provider. At block 524, the wallet server may update a mobile wallet associated with the mobile device. Further, at block 526, the wallet server may transmit the updated wallet to the mobile device. The method may then end at state 514.

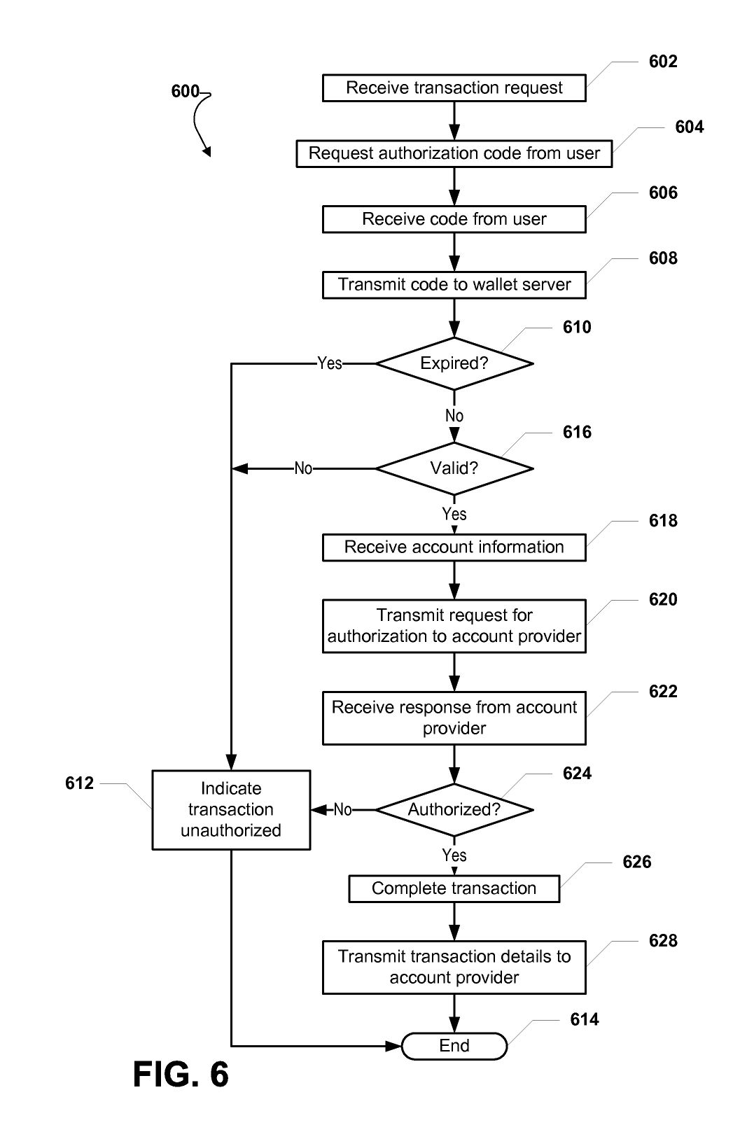

Referring now to FIG. 6, a method of conducting transactions with a mobile device at a point-of-sale terminal is shown and is generally designated 600. Starting at block 602, the point-of-sale terminal may receive a transaction request from a mobile device. At block 604, the point-of-sale terminal may request an authorization code from the user, or the mobile device. At block 606, the point-of-sale terminal may receive the code from the user. Moving to block 608, the point-of-sale terminal may transmit the code to the wallet server.

At decision step 610, the point-of-sale terminal may receive an indication of whether or not the code is expired. If so, the method 600 may proceed to block 612 and the point-of-sale terminal may indicate that the transaction is unauthorized. Then, the method may end at state 614. Returning to decision step 610, if the code is not expired, the method may continue to decision step 616 and the point-of-sale terminal may receive and indication of whether or not the code is valid. If not, the method 600 may continue to block 612 and continue as described herein. Otherwise, if the code is valid, the method 600 may move to block 618 and the point-of-sale terminal may receive account information.

Proceeding to block 620, the point-of-sale terminal may transmit a request for authorization to the account provider. At block 622, the point-of-sale terminal may receive a response from the account provider. At block 624, the point-of-sale terminal may determine whether the transaction is authorized. If not, the method 600 may move to block 612 and continue as described herein. If the transaction is authorized, the method may move to block 614 and the point-of-sale terminal may complete the transaction. At block 628, the point-of-sale terminal may transmit the transaction details to the account provider. The method may then end at state 614.

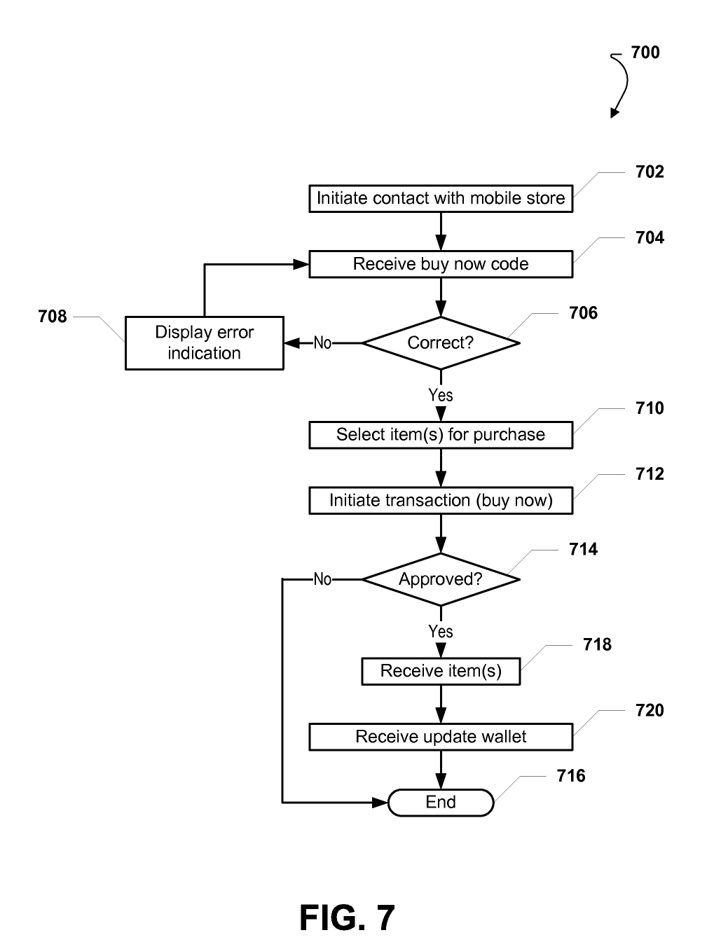

FIG. 7 illustrates a method of conducting transactions with a mobile store from a mobile device. The method is generally designated 700 and begins at block 702. At block 702, the mobile device initiates contact with a mobile store. During the contact, the mobile device may receive one or more special offers from the mobile store. Further, the mobile device may receive one or more coupons from the mobile store. At block 704, the mobile device may receive a buy now code. Moving to decision step 706, the mobile device may determine whether the buy now code is correct. If not, the method 700 may proceed to block 708 and the mobile device may display an error indication.

If the buy now code is correct, the method may continue to bock 710 and the mobile device may select one or more items for purchase. At block 712, the mobile device may initiate a transaction with the mobile store. In a particular aspect, the transaction may be initiated after a user selects a buy now button at the mobile device. Further, the transaction may include the acceptance of a special offer stored within a mobile wallet at the mobile device or the transaction may include the user of an electronic coupon stored within a mobile wallet at the mobile device.

Moving to decision step 714, the mobile device may receive an indication of whether or not the transaction is approved. If not, the method may end at state 716. If the transaction is approved, the method 700 may continue to block 718 and the mobile device may receive the item, e.g., if the item may be transmitted electronically. Such items may include tickets, gift cards, etc. The mobile device may also receive an electronic receipt. At block 720, the mobile device may include an update wallet. The method may then end at state 716.

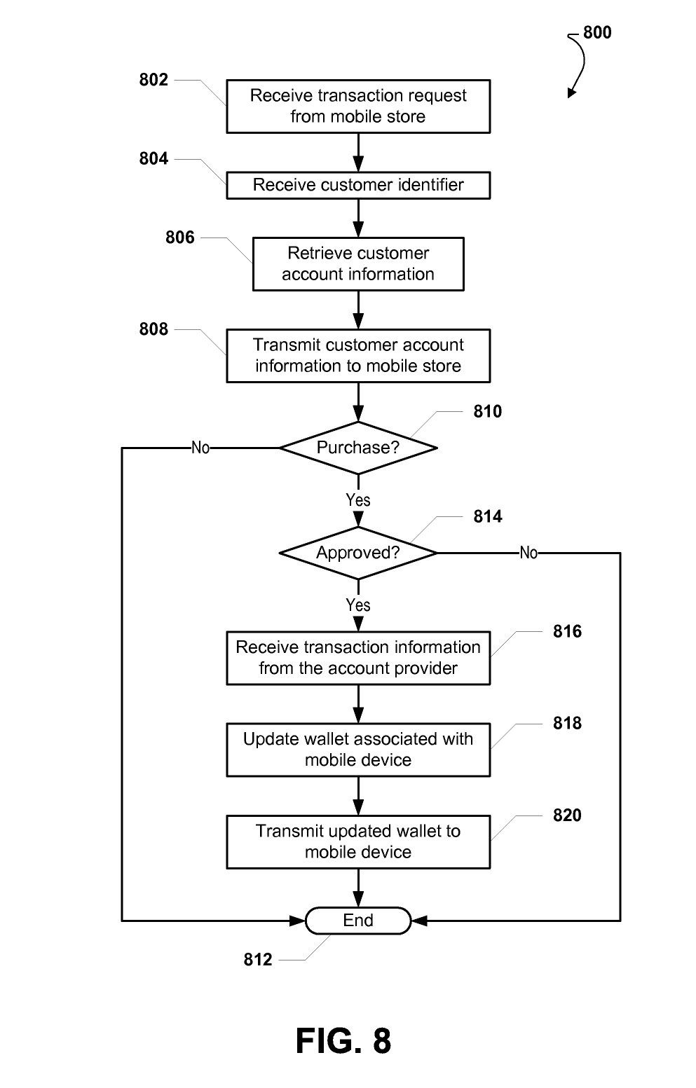

Referring now to FIG. 8, a method of managing transactions between a mobile device and a mobile store at a wallet server is shown and is generally designated 800. Beginning at block 802, a transaction request may be received from the mobile store. At block 804, a customer identifier may be received from the mobile store. At block 806, the wallet server may retrieve customer account information, e.g., from a mobile wallet stored within a database and associated with the customer identifier. At block 808, the wallet server may transmit the customer account information to the mobile store.

Moving to decision step 810, the wallet server may receive an indication of whether the user has completed a purchase. If not, the method 800 may end at state 812. Otherwise, the method 800 may proceed to decision step 814 and the wallet server may receive an indication of whether or not the transaction is approved. If not, the method 800 may end at state 812. If the transaction is approved, the method 800 may continue to block 816 and the wallet server may receive transaction information from the account provider. At block 818, the wallet server may update the mobile wallet associated with the mobile device. Further, at block 820, the wallet server may transmit the update mobile wallet to the mobile device. The method may then end at state 812.

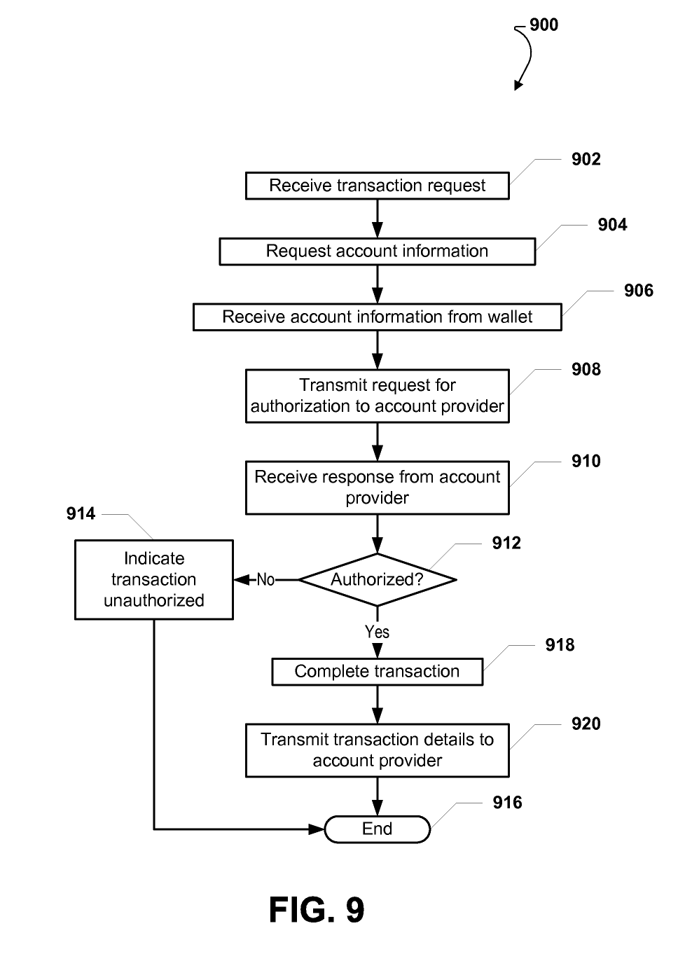

Referring now to FIG. 9, a method of conducting transactions with a mobile device at a mobile store is shown and is generally designated 900. Commencing at block 902, the mobile store may receive a transaction request from a mobile device. At block 904, the mobile store may request account information from a wallet server. The mobile store may include a customer identifier with the request for the account information. Moving to block 906, the mobile store may include account information from the wallet server.

At block 908, the mobile store may transmit a request for authorization to an account provider. At block 910, the mobile store may receive a response from the account provider. Continuing to decision step 912, the mobile store may determine whether the transaction is authorized by the account provider. If not, the method 900 may proceed to block 914 and the mobile store may indicate to the mobile device that the transaction is unauthorized. Thereafter, the method may end at state 916.

Returning to decision step 912, if the transaction is authorized, the method 900 may proceed to block 918 and the mobile store may complete the transaction with the mobile device. For example, the mobile store may ship the item electronically or physically. Moving to block 920, the mobile server may transmit the transaction details to the account provider. Then, the method may end at state 916.

It is to be understood that the method steps described herein do not necessarily have to be performed in the order as described. Further, words such as “thereafter”, “then”, “next”, etc. are not intended to limit the order of the steps. These words are simply used to guide the reader through the description of the method steps.

With the configuration described herein, the system and method disclosed herein provides a relatively easy way for a user to shop using a mobile wallet stored in a mobile device.

In a particular aspect, the mobile wallet may provide a flexible and efficient way to search providers by name or by using a unique short code. Provider searches may be filtered based on parameters such as new or featured. A mobile wallet user may enter a unique provider code that may not only provide a relatively quick way to locate a provider, but also be linked with cross-media promotions. Alternatively, a user may enter a provider name, e.g., a full name or a partial name in order to find a provider. To make things as easy as possible for the user, a flexible auto-complete suggestion mechanism may be provided. Further, a user may filter a search based upon provider parameters such as: new, featured, type, category, function, etc.

In another aspect, users may select or view providers by a number of searchable parameters. For example, users may browse providers by function. Further, users may browse providers alphabetically by name. Also, users may browse providers by type, e.g., banks, credit unions, merchant/retailer, membership, biller, etc. Users may also browse all providers, recently used providers, saved providers, featured providers, or a combination thereof. In a particular aspect, the system may monitor provider usage and a user may browse the providers based on popularity. Also, users may browse new providers or browse providers by category, e.g., gift cards, clothing, electronics, music, etc.

A user may search providers based upon a specific, desired function. Selecting a provider may direct a user to a my accounts screen or in the case of an individual provider, to a provider home screen. Alternatively, selecting a provider may take a user directly to a function screen within an individual Provider. In another aspect, a user may browse by buy gift cards, by get gift card balance; by get offers; by get loyalty/rewards account, or a combination thereof.

The system and method disclosed herein also allows a user to save providers in a mobile wallet for ease of reference and use in the future. A user may save individual providers. Also, a user may save a result set, i.e., a group of providers returned in response to a search. A user can set the system to automatically save a provider if the user performs any function, or functions, with the provider. A user may delete a provider which may cause a provider to be un-enrolled from the mobile wallet. However, the deleted provider may be re-added at a later stage. Deleted providers may be archived for potential “undos” in the case of accidental deletion or for archival reference.

In a particular aspect, the system and method may provide a relatively flexible, easy, and intuitive way to enroll a user with a Provider and to track the enrollment within the Wallet. Initially, a minimum amount of user information to establish identity may be collected or a light-weight enrollment process may be performed to minimize enrollment abandonment. The mobile wallet enrollment process may include enabling provider accounts, activating payment accounts, establishing a user profile and preferences, etc. A user may create a password to be used online and a user identification.

The mobile wallet allows a user to easily add one or more provider issued accounts to the mobile wallet or perform maintenance on existing provider accounts. After enrolling a provider in the wallet, a user may enroll or add accounts issued by the provider. The user may provide account details for the account the user would like to enroll. The provider may determine which account details are required to identify the account, e.g., account number, PIN, or other parameter(s) required by provider. The user may further provide additional information to authenticate with the provider, including but not limited to online account credentials, account PIN/Password, mother's maiden name, etc. Since the physical possession of the phone provides stronger (yet still soft) authentication than on-line, a light-weight authentication may be provided to minimize usage friction. However, a stronger authentication may be provided to adapt to stricter security standards of many providers.

After provider accounts are enrolled, and depending on the wallet server's interface with the provider, a user may be required to perform maintenance on the accounts to ensure they remain active in the mobile wallet. In a particular aspect, a user may edit the name on an account to bring it current with the provider's records. Further, a user may update an expiration date to match a current expiration date. Also, a user may update additional account details as required by the provider or by the wallet server.

After a provider accounts is activated, a user may view the provider account and the details associated with the account. After a provider account is enrolled, a user may remove it from the wallet. However, an archival record of the account's existence in the mobile wallet may be provided.

After a provider is enrolled and eligible provider accounts have been successfully added to the wallet, a user may activate the eligible accounts to be used as payment accounts. A user may activate a payment account from the provider's landing experience, i.e., how the provider initially represents itself to a visiting user. The user may also activate a payment account from a list of all eligible payment accounts or from a “trigger” screen where a payment account is required to complete a process, e.g., checkout—select payment method.

In a particular aspect, a user may be presented with a list of all enrolled provider accounts that are eligible to be activated for payment. Accounts already activated for payment may be identified. After selecting an eligible account, the user may activate the account for payment. The process for activating an account for payment may vary depending on the wallet server interface with the provider. A user may not be required to enter account information. The account information may be supplied through an API. However, the user may be required to provide a card verification number.

A user may select an individual account for activation or multiple accounts for activation. If the system identifies additional eligible provider accounts, the user may be allowed to initiate the activation process for all eligible accounts. Depending on the interface between the wallet server and the provider, the user may be required to enter all or some account information. The wallet server may store all user entered account data with the exception of the card verification number (CVN). Where account details are pre-populated, the user may view the pre-populated information but may not modify it. The user may also supply missing required account information, e.g., card/account number, card expiration date, name on card/account, billing address, phone number, etc. In certain situations, a user may enter a CVN to support account verification with the provider and/or generation of a pre-authorization transaction to verify the account. The wallet server may provide examples of where to find the CVN, i.e., based on the card type. A user may optionally save an account billing address to his or her address book. Also, a user may optionally designate an account as his or her default payment account. Further, a user may view the provider's terms of service and may need to confirm acceptance to proceed. A user may also confirm that an account should be activated for payment.

After a payment accounts is activated, a user may view active payment accounts and see the details associated with the account. For example, a user may view a card/account number, card expiration date, name on card/Account, CVN, customer service phone numbers, supported ATM networks, and other information related to the account such as billing Address and billing Phone. By providing such card details, the mobile wallet may be used as a replacement for a physical wallet. Further, by providing easy access to account details, a user may to store plastic cards and use the mobile representation of the cards when making purchases, e.g., online, over the phone, and some point of sale.

In a particular aspect, after a payment account is enrolled, a user may be required to perform maintenance on the payment account to ensure the account remains active in the wallet and is accepted for payment. The user may edit an expiration date to match a current expiration date. Further, the user may edit the name on an account to match the current name on a card on record with the provider. The user may also update the billing address to match the current billing address on record with the provider.

After a payment account is activated, a user may de-activate it. The account will no longer be available as a payment method for purchases. However, the account may be re-activated through the activate payment account process to become available for payments in the future.

In a particular aspect, a user may determine the display order for payment accounts. This setting may control how payment accounts appear in the active payment accounts list, at checkout, or on any screen where only payment accounts are listed. The user may select a payment account and promote/demote the account to any position within the payment account stack. The user may repeat this process with one or more accounts until complete. Further, the user may select a pre-defined sort order, e.g., by account type, by available balance, by provider, etc. However, a user may elect to always display a given provider's accounts first at checkout when purchasing from that provider. This ensures that the provider's gift cards, credit card, debit cards, and/or rewards accounts always appear at the top of the list giving the user the opportunity to use those first for payment. A user may optionally designate an account as the default payment account. This account may be automatically selected for payment regardless of its position in the payment account list display order.

The system and method provided herein also enables providers to sell products to users through the mobile wallet. The system and method enables the purchase of physical goods (virtually any product), mobile downloadable content (music, wallpaper, images), and over-the-air deliverable tokens (e-tickets, access codes, license keys). In addition, the system and method may capture delivery information to ensure fulfillment of the order, may support real-time order status, and may allow users to save purchase confirmations, receipts and tokens in a durable and reliable manner.

The system and method further provides product discovery to enable the user to find products in the mobile wallet. Each Provider may have one or more catalogs for products. Products may include various searchable parameters associated with them, including, but not necessarily limited to: category, type, featured, occasion, gift cards, new, popularity, price, etc. A user may also search or view products via various search dimensions including: browse by category, type, featured, occasion, gift cards, new, popularity, price, price range, etc. A user may also search or view products based upon keyword matches, filters, or a combination thereof. After selecting a product, a user may be presented with product details.

The system and method also provides a buy now feature that allows a user to enter a buy now code to find a product for purchase. The buy now feature provides users with relatively easy access to individual products, while allowing providers to continue marketing products via print, television, radio, and online advertising. A user may access a product details page for a product by entering a buy now code, e.g., 5787. Also, a user may access a product details page for a product by scanning a buy now barcode. Further, using a NFC capable handset, a user may access a product details page for a product by tapping an NFC smart tag. Product codes may be determined by the providers. Providers may use existing product codes or define custom buy now product codes. Alpha-numeric buy now codes may be used. However, numerical buy now codes may limit input errors and ensure an acceptable user experience. The system may further support product codes that include a provider identifier, e.g., 300-5787.

The system and method provides a featured products feature that allows a user to view a set of featured products and make a selection for purchase. This provides a way for providers to market to and to attract users to their catalog(s), service(s), or a combination thereof. A custom featured products may be provided to allow providers to establish multiple, custom featured products groups. Providers may define multiple custom groups of featured products, e.g., gift cards, weekly specials, deal of the day, etc. Providers may designate the menu label for each group. Presentation of the featured products may be standardized or may be custom. Further, the products featured may be chosen by the provider and may be defined in the product catalog. Product images and the order in which the products are displayed may be determined by the provider. Also, providers may be able to control the display of the featured product group by customer segment.

A user may view available featured product groups by name, e.g., new, featured, for her, etc. Featured product groups may be displayed to all users or may be segmented by user type. If shown a featured product group, the user may select the group and proceed to view the featured products. The featured products screen may include the summary information about the featured products. Summary information may include: image, product name, product category, price, etc. The summary information may be defined by the provider. A user may select a product to view product details. Buy gift cards may be made available to providers as a pre-defined featured product group. The Provider may use this group as defined by assigning gift card products to the group, or may update/disable the group. A user may select buy gift cards to view the featured gift card products. A gift card products screen may display summary information about the featured gift cards. The summary information may include: image, product name, card types (plastic and/or e-card), etc. The summary information may be defined by the Provider. A user may select a card to view product details.

In a particular aspect, the product details screen may provides details about the selected product and may allow the user to select product attributes. The product details screen may include a brief product description, an image of the product, shipping timing and product inventory status, terms and conditions (as determined by the provider and stored in the product catalog), or a combination thereof. The product details screen may also include product attribute selection if more than one attribute option is available. Further, the product details screen may include a product quantity field, e.g., presented as a numeric drop down field, and a product type selection if more than one available.

In a particular aspect, the product details screen may also include gift card denominations that are chosen by the provider and that may be a continuous set of numbers between 1 and 10000+ or a discreet set of integers within the same range. The denominations selected by the provider may determine the user interface. The denominations may be presented as a text box, e.g. a range of 10-1000 with validation limits of 10-1000. Also, the denominations may be presented as a drop down menu, e.g. 25, 50, 100, 250, 500, etc., listed in a drop down box. A provider may select both options as long as the lower limit and upper limit are the same. For example: 10, 50, 100, 200 or 10-200 may be shown as a drop-down and a text box. The product details screen may also include business rules, i.e., instructions for users about product thresholds such as product amount limits or quantities. A user may enter or select product attributes and then, proceed to checkout.

The system and method described herein also includes a wish list function in which the user may select certain products of interest for later action and/or review. A user may save products directly to the wish list from multiple sources, including searched/browsed products, featured products and gift cards. A user may browse wish list items based on several different parameters, such as date saved, provider, product category/type, price, etc. A user may move immediately to purchase from the wish list. Saved products may be removed per a configurable expiration/aging policy or manually. Further, a user may elect to have a reminder or alert to fire based upon pre-defined criteria such as event date, product release/availability, restocking status, etc. Also, a user may export the wish list to others/self via several communication/community mechanisms such as wallet-to-wallet (w2w), text message, E-mail, My Space/FaceBook, etc.

The system and method also provides checkout functionality. After reviewing product details and selecting required product attributes, a user may elect to purchase the product by proceeding to checkout. The user may select a payment account from any active payment accounts supported by the provider. The user may provide additional payment account verification as required. A user may accept a default payment method or select a payment method. If the user does not have active payment accounts, and taking into consideration user's eligible payment account status, the system may provide an appropriate option, e.g., accept default payment account, activate payment account, edit payment account, apply for credit, enroll provider, etc. If a user has established a default payment method, then no action is required to accept the default payment method. A user may select a payment account from any active payment accounts supported by the provider. Payment accounts may be displayed in order based on user preferences or based on a default sort order such as available balance. If the payment method is expired, the user may be taken to the edit active payment account screen for the selected account. The order may be saved until the user returns to the transaction.

In a particular aspect, the user may select activate payment account which may take the user to the view all eligible payment accounts screen. The user may activate a payment account to proceed. The system may save the order until the user returns to the transaction. If no eligible payment accounts are found, the user may be presented with the following options: enroll provider, add and activate payment account, and apply for credit. Selecting the enroll provider option may take the user to the find provider screen. The user may complete the enrollment process and activate a payment account to proceed. The system may save the order until the user returns to the transaction. Selecting the add and activate payment account option may direct the user to the saved providers screen. The user may enroll and activate a payment account to proceed. The system may save the order until the user returns to the transaction. Selecting the apply for credit option may direct the user to the credit application for the current provider. The user may complete the application process and receive a confirmation of credit approval to proceed. The system may save the order until the user returns to the transaction.

After selecting a payment method, the user may be required to provide additional payment method verification details as required by the provider. If required by the provider, and if a debit card or credit card is selected as a payment method, the user may need to provide the card verification number (CVN). A provider may require CVN on the user's first purchase with the provider, or on every purchase. The system may provide example of where to find the CVN, i.e., based on the card type. If the user is allowed to store CVN on the phone, system may allow the user to view it at this point. If required by provider, the user may need to provide an e-mail address. This may be pre-populated and/or selected from address book. Further, if required by the provider, the user may need to enter billing address zip code. This may be required as a fraud prevention step and would be in addition to the billing address information that may be automatically provided by the system. The provider may require that the user provide this information. Additionally, if required by the provider, the user may need to enter a billing address phone number. This may be required as a fraud prevention step and would be in addition to the billing address information that may be automatically provided by the system. The provider may require that user provide this information.

In a particular aspect, the user may choose to split the purchase price across several payment methods, e.g., a standard payment plus a gift card or gift cards, multiple standard payment methods, etc. If the user selects a gift card as the payment method, the system may determine if the gift card has sufficient balance to cover the purchase. If not, the system may prompt the user for additional payment method. If the user selects one or more gift cards as the additional payment method, the system may apply any gift card payments first and charge the remainder to the other payment method. If the user selects a credit/debit card as the additional payment method, the system may allow the user to designate the amount to be taken from each payment method. This step may be completed once the final price is calculated.

A user may elect to add several elements of personalization to the order during the checkout process. This could be a custom message written by the user, or a pre-written message that the user selects. Additionally, the user may want to select a gift wrap and/or gift packaging option. Gifting and personalization may be offered to the User as an up-sell/cross-sell. If the purchase is a gift, the system may direct the user to the gift personalization screen. At the gift personalization screen, the user may enter a custom greeting, message body and/or closing message. The user may select a pre-written message. Also, the user may select gift wrapping/packing options. Further, the user may select or enter a return/sender address. This is intended to be the address of the person who is sending the product. In general, ensures that the recipient recognizes the sender.

In order to enter delivery information, the user may be directed to a delivery information screen that is specific to the type of product selected. For physical delivery, the user may select a shipping address from the address book, find an address, or manually enter a new shipping address. The user may also elect to have the product delivered to a provider location for pick-up. If the user has established a default shipping address, then it should be pre-populated. No action may be required to accept the default shipping address. If the provider requires that the product be shipped to the billing address of the payment account, this will override the user's preference. The product may be shipped to the billing address of the payment account. This may be the only option supported by the provider. Conversely, the product may be shipped to the address selected or entered.

In a particular aspect, the user may find a shipping address by supplying a house number and zip code. The user may select the address from the result set. Particularly, the user may enter the recipient's house number and zip code and selects submit. The user may receive a list of possible addresses located in that zip code. If the list contains the correct address, the user may choose the correct address by navigating to the address and selecting it. If no match is found, the user may proceed to enter required address information. Additionally, in store pickup may be supported and the user may elect to pick the product up at a provider location.

In another aspect, the user may enter/edit required address information. The user may manually enter address information or edit system provided address information. Required fields may be based on provider preferences, e.g., recipient name, recipient company, recipient street 1, recipient address line 2, recipient city, recipient state, recipient zip, recipient country, recipient telephone number, recipient e-mail address, etc. To ensure that the addresses received are legitimate and properly formatted, the system may verify an address at the point of data input.

After providing shipping information, and if the user has established a default shipping method, no action should be required to accept the default shipping method. After providing shipping information, the user may select a shipping method from those supported by the provider. e.g. USPS standard, USPS priority, USPS priority with delivery confirmation, USPS express, common carrier ground, common carrier second day, common carrier next day, etc. The user may be presented with the next available ship date. This is typically the next business day and represents the earliest date that the items will be shipped. It is contingent upon Payment Account authorization.

When supported by the provider, the user may select a future shipping date for the product. This feature may allow the user to place an order for a future holiday, a birthday, or an event and schedule the item to be sent just before that event. The user may receive an approximate delivery time so that the delivery date can be estimated. Once a shipping address and shipping method are selected, the user may have the option to calculate the shipping costs and edit shipping method.

In the case of a mobile delivery, if the purchase is a gift, the user may provide the mobile number of the recipient. Otherwise, the system may automatically ask the user to key a recipient's mobile number. Alternatively, the user may select a mobile number from an address book. In the case of electronic delivery, if the purchase is a gift the user may provide the e-mail address of the recipient, otherwise the system may automatically ask the user to key a recipient's e-mail address. Conversely, the user may select a recipient e-mail address from an address book

During checkout, the user may enter one or more promo/coupon codes. If the provider elects to do so, any relevant offers or coupons that reside in the user's mobile wallet should be automatically detected and incorporated into the order. In the case of a saved order being re-opened and progressed, this check should occur again, in order to incorporate any new offers or coupons that are relevant. Prior to submission, the user may review the various elements of the order. The user may then edit one or more of the order elements. When review is complete, the user may confirm by submitting the order. The user may also have a final opportunity to enter any promotional codes.

At any time during the checkout process prior to order submission, a user may edit any element of the order, without losing the work they have already accomplished. Further, a user may save a transaction at any point in the process after proceed to checkout. A user may submit an order and the system may process and validate all elements immediately, including verification of payment method, in order to return order confirmation, or an error or a failure, status with details. If errors occur, the user may be allowed to cure the errors. Once an order submission is complete, the user may receive an order confirmation that displays a unique identifier for the transaction, as well as a tracking number if it is available at that point. This may be stored elsewhere as well for later reference.

Another feature provided by the system and method includes an orders and receipts feature. The orders and receipts feature allows a user to save and reference orders, receipts and tokens. Stored order confirmations may allow the user to review, track and, if necessary, trouble-shoot any orders. Receipt storage may provide a durable, digital mechanism for users to track their purchases. Tokens refer to records that represent digital purchases that require an alphanumeric code or a graphical code, e.g. a 2D bar code, to redeem or re-redeem, whether the ultimate product or service is on- or off-line.

The user may browse orders and receipts based upon several different order parameters, such as: by date, provider, delivery address, payment account, recipient, etc. Further, the user may view order status including order origination, shipping status (if applicable) and delivery method. The user may view various elements of their orders, including: order status, tracking number (if Available), delivery address, etc. In the case of mobile or electronic delivery of orders, a user will have a more limited view of the relevant order elements, including: order status, delivery address (Mobile Phone/E-mail), etc.

In the event a separate receipt is not issued beyond the order confirmation, the user or provider may flag an order confirmation as a receipt. Also, in the event a separate token is not issued beyond the order confirmation, the user or provider may flag an order confirmation as a token. A user may choose to manually export order, token, or receipt data in one of several standardized formats, e.g., for potential import into a spreadsheet, for printing, etc. Save items may be removed per a configurable expiration policy, an aging policy, or manually.

The system and method described herein may allow providers to extend the reach of loyalty programs and membership programs to mobile devices. This may allow providers to drive real-time information to existing program member to increase spending, reduce churn, shift spending to higher margin products, and will support the acquisition of new customers. A custom program framework may allow providers to define multiple, custom programs areas. Custom program groups may be displayed to all users or may be segmented based on user type. Program details may be supplied by the provider and may be specific to the user. User specific information may be provided to program members; and general program information may be provided to non-members. A user may click to call the member service number specific to the program. If not currently enrolled, a user may enroll in the program via the mobile wallet. If the enrollment involves the delivery of user details to the provider, the user information that will be sent to the provider may be confirmed on-screen and the user may confirm the submission. An in-wallet, e-mail, or text message may be sent to the user to confirm that the enrollment has been sent.

In a particular aspect, the system and method may further include a flexible offers framework. The offers framework may allow providers to market to users, promote strategic products, and incentivize high-value behavior. A user may view list of relevant offers targeted based on based on behavior, demographics, opt-in information, or a combination thereof. A user may view offer details, e.g., offer title, description, expiration information, limitations, conditions, information on transferability, etc. Further, a user may search the offers by any offer parameter or by keyword. A user may enter an offer code to find an offer. The offer code may be a unique code and may facilitate cross-media campaigns

Users may save offer in the mobile wallet and the offers may be automatically detected during the checkout process. Users may also elect to send offers to e-mail addresses. For transferrable offers, a user may share the offer by sending the offer via wallet-to-wallet communication, text messaging, or e-mail. The user may have multiple means to respond to offers that appeal to them. For example, they should be able to buy the product directly, click to call, accept the offer (thus storing it in their Wallet) or redeem the offer directly. Accepting an offer may cause the offer to be saved into the mobile wallet. If the offer is redeemable at checkout it should be automatically detected during the checkout process. If the acceptance involves the delivery of user details to the provider, the user information sent to the provider may be confirmed on-screen and the user may confirm the submission. An in-wallet, e-mail, or text message may be sent to the user confirming that the inquiry has been sent. The offer may further include a click-to-call number that may be a phone number configurable by the provider.

Redeeming an offer may generate a token that may be stored in the wallet and used at the POS to redeem the offer. The token may store the relevant details as well as a either a unique offer Identifier or a graphical redemption image, e.g., a 2D bar code. Selecting buy now should direct the user to the product details page for the offered product. Promotional pricing or coupon may be pre-populated and applied at checkout. A provider may tie the offer to the use of a specific payment method and this limitation may be enforced at Checkout. If an offer results in a zero dollar transaction, the user may still receive an order confirmation. Expired offers may be removed in an automated fashion, potentially with the option to have a reminder, or alert, triggered immediately prior to expiration. A user may also elect to remove offers at any time.

The system and method described herein also provides gift card services that may allow a user to get gift card balances, save gift cards, and refresh, reload, or top up the balance on a saved gift card. A user may request a gift card balance by: entering a gift card number, entering a gift card PIN, or supplying other gift card details. A user may enter the gift card number and the system may display a provider specific example showing where to locate the card number. For maximum usability, the system may support pre-populating a portion of the card number or only require the user to enter the last X digits of the card number. Further, a user may enter the gift card PIN number and the system may display provider specific examples showing where to locate the PIN number. Depending on the provider's requirements, a user may be required to provide other gift card details to obtain a balance. A gift card balance response may include a card number, a PIN number, a balance, a provider marketing message, etc.

After gift card details have been entered and a balance successfully obtained, a user may save a gift card to the mobile wallet. The system may store the last balance pulled for the gift card, but the provider may determine if gift card balances should automatically be refreshed. If a balance is not automatically refreshed at login, a user may manually request to refresh the gift card balance. If supported by the Provider, a user may click to call an IVR/VRU system to obtain a balance or access customer service.

In a particular aspect, the system and method described herein also provides for account acquisition that may allow a user to open or request accounts from the provider. A user may complete a credit application to apply for a provider's credit card. If approved, the account may be immediately provisioned and enabled in the mobile wallet. A user may view and choose from the provider's available card products and designs. To complete an application, the user may provide requested application information. Some of this information may be pre-populated from the user's mobile wallet profile. For example, this information may include name, address, phone, SSN, income, date of birth, drivers license number and state, credit amount requested, etc. A user may review and acknowledge acceptance of provided disclosures and terms of service. Further, the user may submit the credit application.

In response to the user submission, the system may present the user with a confirmation that the application was received. If an instant decision is available, the user may receive an immediate approval, a soft decline, a hard decline, or some other status or response. System may to support provider defined responses which may include a customer service number to call to complete the application or to request more information on the decision. When a real-time decision is not available, a user may check the application status after receiving an alert or at any time by requesting a status update.

If the credit application is approved, the user may add the payment account to the mobile wallet and begin to transact in the mobile wallet. The user may request to add another account, e.g., checking, savings, etc., to an existing relationship.

The system and method herein may provide usage analytics which will assist providers in targeting relevant and compelling messages to the users. The system may track and analyze how users are searching and for what they are searching. The system may track user location data to analyze user geographic patterns for location-relevant targeting. The system may also track the offers that are viewed and ultimately accepted or abandoned. Further, the system may track behavior through the checkout process in order to predict what causes successful or unsuccessful completion of the checkout process. Also, the system may track and analyze how products are viewed and exited, including source tracking as there are multiple ways to get to product detail pages. The system may also track wish lists, since the users are volunteering what products or services are most interest to them. Further, tracking the most/least frequently accessed account maintenance features may provide valuable usability insights.

The system and method described herein may also include a store locator that may allow a user to find a provider's locations in a given locale or specific to the user's position. The wallet may automatically identify stores close to the User's present location. The user may be presented with a list of store locations within a given distance of her current location. The user may change increase or decrease the range. Further, the user may select a location and choose to view text-based directions within the mobile wallet. The user may also select a location and choose to launch a navigation application to view a map with turn-by-turn directions. The user may also search store locations by zip code or city and state. The user may be presented with a list of store locations within a given distance of the provided zip code and the user may change increase or decrease the range.

The system and method herein also provides a user profile that may allow a user to record personal information for later use when making purchases, applying for credit, accepting offers, enrolling in programs, requesting information, or submitting contest/sweepstake entries. The user profile may also allow the user to view and maintain information automatically gathered by the system over time i.e., address book entries, credentials, and usage and interest data. Information recorded in the user profile will be pre-populated and/or made available for selection on form screens and submissions whenever possible to simplify and streamline the mobile experience for the user. The user may record and maintain personal information for use in mobile commerce and financial services activities throughout the mobile wallet. Further, the user may view and edit personal information including: name, sex, date of birth, mobile phone, land phone, e-mail address, etc.

The user may record and maintain shipping addresses, including recipient name and phone, for use as a billing address and destination address in mobile commerce and financial services activities throughout the mobile wallet. Also, the user may add new address book entries. Addresses may be the user's own addresses or may be those of friends or family members to whom the user may want to send gifts. Address record should include full name, shipping address, and phone number. The user may edit, copy & edit, or remove existing address book entries. Additionally, the user may record and maintain personal preference and interest information such as communication preferences and marketing/product interests. A user may elect to share this information with providers to enhance the mobile commerce and mobile financial services experience.

A user may record and maintain communication method preferences for all notifications, and alerts generated by the mobile wallet. Possible options may include text message, e-mail, in-wallet, secure message, etc. The user may also record and maintain preferences (Opt-In/Opt-Out) for all general and marketing notifications. Example notifications include: order updates and confirmations, shipping confirmations, customer service inquiries, legal notices, new products, research surveys, expiration notices, featured providers, special offers, available to order notifications, etc. A customer service inquiry may include confirmation that an inquiry has been received. The legal notices may include terms and conditions of using the mobile wallet as determined by the user's saved providers and by the wallet server and the carriers. If a user chooses not to receive legal notices in-wallet, or by e-mail or text message, the user may need to check the provider web site to stay updated on provider policy changes. The new product notification may include new product announcements from saved Providers. The new product notifications may be targeted based on past purchases, preferences, etc. Research surveys may include mobile wallet feedback, provider feedback reminders, and other customer surveys. Expiration notices may include expiration notices on active payment accounts, purchased tokens, accepted offers, etc. Featured provider notifications may include new, featured Provider announcements that may be targeted and untargeted as determine by the carrier and the wallet server. Special offer notifications may include notice of new offers, sales, new provider launches, important new mobile wallet features, contests, sweepstakes, and other promotional announcements, as determined by the carrier and the wallet server. Available to order notifications may include notice of when an out-of-stock item is once again available or when a wish list item or highly anticipated items such as new DVDs are officially released and able to be ordered. A user may also provide information about her interests. This information may be shared with providers in the mobile wallet to facilitate promotions, exclusive mobile offers and delivery of information targeted to the users' indicated interests.

In a particular aspect, a user may configure, including opt-out, a setting that controls how the wallet server and the carriers may use and share information collected from activities and interactions in the mobile wallet, e.g. purchase activities, search history, wish lists, viewed and saved offers, and provider relationships. A user may set allowances for specific categories of use or may decline all. Example categories include: marketing, customer service, product recommendations, etc.

In a particular aspect, a user may create and maintain a mobile payment transaction PIN. This may be a mobile wallet level PIN meaning it would not be Provider specific. The Providers would not need to know the PIN or verify it, but would want to know that the wallet server has verified the PIN. A user may set preferences for receiving confirmation messages and receipts. Options should include in-wallet, text message, and/or e-mail. Further, a user may record and maintain credentials for providers. This may be necessary in cases where the user's online credentials must be maintained by the wallet server for continued access. This may allow users who infrequently visit a provider's web site to recall online credentials. A user may establish security preferences for the wallet and change security defaults. Further, a user may override the default PIN retries setting with a user setting. Also, a user may set PIN recovery options. A user may also set out-of-band, i.e., not delivered to the same mobile device, alerts for activities that occur in the mobile wallet. Alertable activities may include: modifying security preferences, adding or modifying a payment account, completing a mobile purchase, applying for credit, personal profile changes, and adding/modifying a provider.

The system and method may further provide “Shortcuts” to frequently used segments of the mobile wallet. The user may relatively easily save a shortcut to a function from any screen within a function.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of managing transactions between a mobile wallet within a mobile device and a point-of-sale terminal at a merchant, the method comprising:
receiving a request for a purchase code from the mobile wallet;
generating a short-term purchase code;
transmitting the short-term purchase code to the mobile wallet; and
receiving the short-term purchase code from the merchant.

2. The method of claim 1, further comprising:
determining whether the short-term purchase code is expired;
determining whether the short-term purchase code is valid; and
transmitting user account information to the merchant when the short-term purchase code is not expired and is valid.

3. The method of claim 2, further comprising:
receiving transaction information from an account provider.

4. The method of claim 3, further comprising:
updating the mobile wallet associated with the mobile device to include the transaction information from the account provider.

5. The method of claim 4, further comprising:
transmitting an updated wallet to the mobile device.

6. A server for managing transactions between a mobile wallet within a mobile device and a point-of-sale terminal at a merchant, the server comprising:
means for receiving a request for a purchase code from the mobile wallet;
means for generating a short-term purchase code;
means for transmitting the short-term purchase code to the mobile wallet; and
means for receiving the short-term purchase code from the merchant.

7. The server of claim 6, further comprising:
means for determining whether the short-term purchase code is expired;
means for determining whether the short-term purchase code is valid; and
means for transmitting user account information to the merchant when the short-term purchase code is not expired and is valid.

8. The server of claim 7, further comprising:
means for receiving transaction information from an account provider.

9. The server of claim 8, further comprising:
means for updating the mobile wallet associated with the mobile device to include the transaction information from the account provider.

10. The server of claim 9, further comprising:
means for transmitting an updated wallet to the mobile device.

11. A server for managing transactions between a mobile wallet within a mobile device and a point-of-sale terminal at a merchant, the server comprising:
a processor operable to:
receive a request for a purchase code from the mobile wallet;
generate a short-term purchase code;
transmit the short-term purchase code to the mobile wallet; and
receive the short-term purchase code from the merchant.

12. The server of claim 11, wherein the processor is further operable to:
determine whether the short-term purchase code is expired;
determine whether the short-term purchase code is valid; and
transmit user account information to the merchant when the short-term purchase code is not expired and is valid.

13. The server of claim 12, wherein the processor is further operable to:
receive transaction information from an account provider.

14. The server of claim 13, wherein the processor is further operable to:
update the mobile wallet associated with the mobile device to include the transaction information from the account provider.

15. The server of claim 14, wherein the processor is further operable to:
transmit an updated wallet to the mobile device.

16. A computer program product, comprising:
a computer-readable medium, comprising:
at least one instruction for receiving a request for a purchase code from the mobile wallet;
at least one instruction for generating a short-term purchase code;
at least one instruction for transmitting the short-term purchase code to the mobile wallet; and
at least one instruction for receiving the short-term purchase code from the merchant.

17. The computer program product of claim 16, wherein the computer-readable medium further comprises:
at least one instruction for determining whether the short-term purchase code is expired;
at least one instruction for determining whether the short-term purchase code is valid; and
at least one instruction for transmitting user account information to the merchant when the short-term purchase code is not expired and is valid.

18. The computer program product of claim 17, wherein the computer-readable medium further comprises:
at least one instruction for receiving transaction information from an account provider.

19. The computer program product of claim 18, wherein the computer-readable medium further comprises:
at least one instruction for updating the mobile wallet associated with the mobile device to include the transaction information from the account provider.

20. The computer program product of claim 19, wherein the computer-readable medium further comprises:
at least one instruction for transmitting an updated wallet to the mobile device.

21. A method of managing transactions between a mobile wallet within a mobile device and a mobile store, the method comprising:
receiving a transaction request from the mobile store;
receiving a customer identifier from the mobile store;
retrieving the mobile wallet associated with the mobile device; and
retrieving customer account information from the mobile wallet.

22. The method of claim 21, wherein the customer account information includes at least one of the following: a preferred payment account, a default billing address, and a default shipping address.

23. The method of claim 21, further comprising:
receiving transaction information from an account provider, when the transaction is approved.

24. The method of claim 23, further comprising:
updating the mobile wallet associated with the mobile device.

25. The method of claim 24, further comprising:
transmitting an updated wallet to the mobile device.

26. A server for managing transactions between a mobile wallet within a mobile device and a mobile store, the server comprising:
means for receiving a transaction request from the mobile store;
means for receiving a customer identifier from the mobile store;
means for retrieving the mobile wallet associated with the mobile device; and
means for retrieving customer account information from the mobile wallet.

27. The server of claim 26, wherein the customer account information includes at least one of the following: a preferred payment account, a default billing address, and a default shipping address.

28. The server of claim 26, further comprising:
means for receiving transaction information from an account provider, when the transaction is approved.

29. The server of claim 28, further comprising:
means for updating the mobile wallet associated with the mobile device.

30. The server of claim 29, further comprising:
means for transmitting an updated wallet to the mobile device.

31. A server for managing transactions between a mobile wallet within a mobile device and a mobile store, the server comprising:
a processor operable to:
receive a transaction request from the mobile store;
receive a customer identifier from the mobile store;
retrieve the mobile wallet associated with the mobile device; and
retrieve customer account information from the mobile wallet.

32. The server of claim 31, wherein the customer account information includes at least one of the following: a preferred payment account, a default billing address, and a default shipping address.

33. The server of claim 31, wherein the processor is further operable to:
receive transaction information from an account provider, when the transaction is approved.

34. The server of claim 33, wherein the processor is further operable to:
update the mobile wallet associated with the mobile device.

35. The server of claim 34, wherein the processor is further operable to:
transmit an updated wallet to the mobile device.

36. A computer program product, comprising:
a computer-readable medium, comprising:
at least one instruction for receiving a transaction request from the mobile store;
at least one instruction for receiving a customer identifier from the mobile store;
at least one instruction for retrieving the mobile wallet associated with the mobile device; and
at least one instruction for retrieving customer account information from the mobile wallet.

37. The server of claim 36, wherein the customer account information includes at least one of the following: a preferred payment account, a default billing address, and a default shipping address.

38. The server of claim 36, wherein the computer-readable medium further comprises:
at least one instruction for receiving transaction information from an account provider, when the transaction is approved.

39. The server of claim 38, wherein the computer-readable medium further comprises:
at least one instruction for updating the mobile wallet associated with the mobile device.

40. The server of claim 39, wherein the computer-readable medium further comprises:
at least one instruction for transmitting an updated wallet to the mobile device.
